(19) United States
(12) Patent Application Publication
(10) Pub. No.: US 2015/0235344 A1
(43) Pub. Date: Aug. 20, 2015

(54) IMAGE MAGNIFIER WITH FOCUS PLUS CONTEXT

(71) Applicant: International Business Machines Corporation, Armonk, NY (US)

(72) Inventors: Jian Wen Chi, Shanghai (CN); Richard W. Ragan, JR., Round Rock, TX (US); Yue Yuan, Shanghai (CN); Jian Zhang, Shanghai (CN)

(73) Assignee: International Business Machines Corporation, Armonk, NY (US)

(21) Appl. No.: 14/182,464

(22) Filed: Feb. 18, 2014

(51) Int. Cl. G06T 3/40; G06T 5/50; G06T 3/00

(52) U.S. Cl. CPC G06T 3/40; G06T 3/0093; G06T 5/50; G06T 2207/10004

(57) ABSTRACT

In an approach for magnifying areas of an image displayed on a computing device, one or more computer processors copy an image displayed on a computing device. The one or more computer processors divide the copied image into at least two areas, wherein a first area is a portion of the image to be magnified and a second area is a portion of the image to be visually compressed. The one or more computer processors render the first area as a magnified image. The one or more computer processors render the second area as a visually compressed image. The one or more computer processors combine the magnified image and the visually compressed image into a new image. The one or more computer processors display the new image.

### FIELD OF THE INVENTION

The present invention relates generally to the field of computer graphics processing, and more particularly to image magnification on a computing device.

### BACKGROUND

Low vision is defined as a condition in which a person's vision cannot be fully corrected by glasses, thus interfering with daily activities such as reading and driving. Low vision is more common among the elderly, but it can occur in individuals of any age as a result of such conditions as macular degeneration, glaucoma, diabetic retinopathy, or cataracts. A common type of low vision is loss of peripheral (side) vision. Loss of peripheral vision is typified by an inability to distinguish anything to one side or both sides, or anything directly above and/or below eye level. Central vision remains, however, making it possible to see directly ahead. Typically, loss of peripheral vision may affect mobility and, if severe, can slow reading speed as a result of the ability to see only a few words at a time. This is sometimes referred to as “tunnel vision”. When a person with tunnel vision reads content on a computer screen, the content appears as if the person is looking through a straw, since only a small portion of the screen is visible.

The most common assistive technology for a person with tunnel vision is a screen magnifier. A screen magnifier is software that interfaces with a computer's graphical output to present enlarged screen content. A magnified portion of the original screen content is displayed on a computer screen (or another type of graphical output from the computer), such that the magnified portion covers some of, or the entire, screen. The magnified portion contains the content that is of interest to a user and acts as a pointer or cursor. The user may move the magnified area around the computer screen with, for example, a mouse, and the screen magnifier alters the enlarged portion to track the mouse movement.

### SUMMARY

Embodiments of the present invention disclose a method, computer program product, and system for magnifying areas of an image displayed on a computing device, one or more computer processors copy an image displayed on a computing device. The one or more computer processors divide the copied image into at least two areas, wherein a first area is a portion of the image to be magnified and a second area is a portion of the image to be visually compressed. The one or more computer processors render the first area as a magnified image. The one or more computer processors render the second area as a visually compressed image. The one or more computer processors combine the magnified image and the visually compressed image into a new image. The one or more computer processors display the new image.

### BRIEF DESCRIPTION OF THE SEVERAL VIEWS OF THE DRAWINGS

FIG. 1 is a functional block diagram illustrating a distributed data processing environment, in accordance with an embodiment of the present invention.

FIG. 2 is a flowchart depicting operational steps of a magnification program, on a client computing device within the distributed data processing environment of FIG. 1, for magnifying areas of an image displayed on a computing device with visible context, in accordance with an embodiment of the present invention.

FIGS. 3A and 3B illustrate an example of magnified text in the center of a computer screen, in accordance with an embodiment of the present invention.

FIGS. 4A and 4B illustrate an example of magnified text in the lower right portion of a computer screen, in accordance with an embodiment of the present invention.

FIG. 5 depicts a block diagram of components of the client computing device executing the magnification program, in accordance with an embodiment of the present invention.

### DETAILED DESCRIPTION

Although generally helpful, most screen magnifying software offers no visual cues to help a low vision user anticipate the contents outside of their field of view. The viewable portion of the screen is magnified, and only a small amount of information is visible at one time. In general, it is easy, especially for users with tunnel vision, to lose context. Important content outside of the field of view can easily go unnoticed.

Embodiments of the present invention recognize that screen magnifying software can be enhanced by providing the user with a visual cue for the contents immediately outside of the narrow field of view. Implementation of embodiments of the invention may take a variety of forms, and exemplary implementation details are discussed subsequently with reference to the Figures.

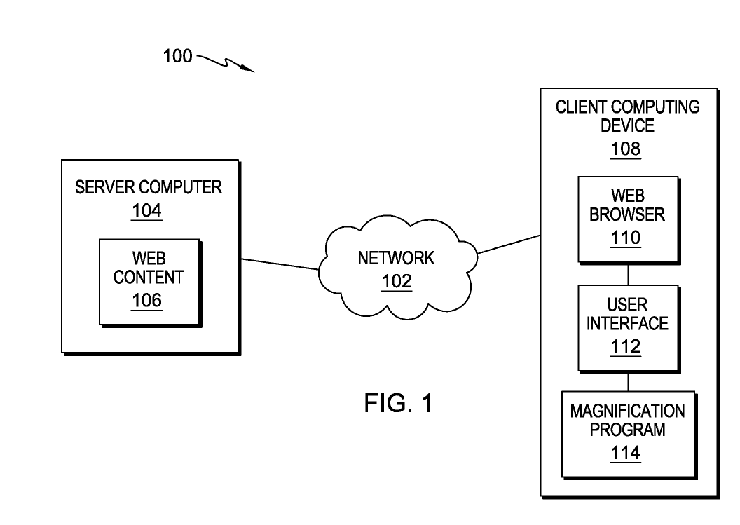

FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Distributed data processing environment 100 includes server computer 104 and client computing device 108, interconnected over network 102. Network 102 can be, for example, a local area network (LAN), a wide area network (WAN), such as the Internet, or a combination of the two, and can include wired, wireless, or fiber optic connections. In general, network 102 can be any combination of connections and protocols that will support communications between server computer 104 and client computing device 108.

Server computer 104 may be a management server, a web server, or any other electronic device or computing system capable of receiving and sending data. In other embodiments, server computer 104 may represent a server computing system utilizing multiple computers as a server system, such as in a cloud computing environment. In another embodiment, server computer 104 may be a laptop computer, a tablet computer, a netbook computer, a personal computer (PC), a desktop computer, a personal digital assistant (PDA), a smart phone, or any programmable electronic device capable of communicating with client computing device 108 via network 102. In another embodiment, server computer 104 represents a computing system utilizing clustered computers and components to act as a single pool of seamless resources. Server computer 104 includes web content 106.

Web content 106 may be any data or application hosted by a web server for access by a web browser. Web content 106 is the textual, visual, or aural content that is encountered as part of the user experience on websites. Web content 106 may include text, images, sounds, videos, and animations. Web content 106 may be a web page, a database, a computer program, such as a game, or any other computer software/application a user may access from client computing device 108 via network 102.

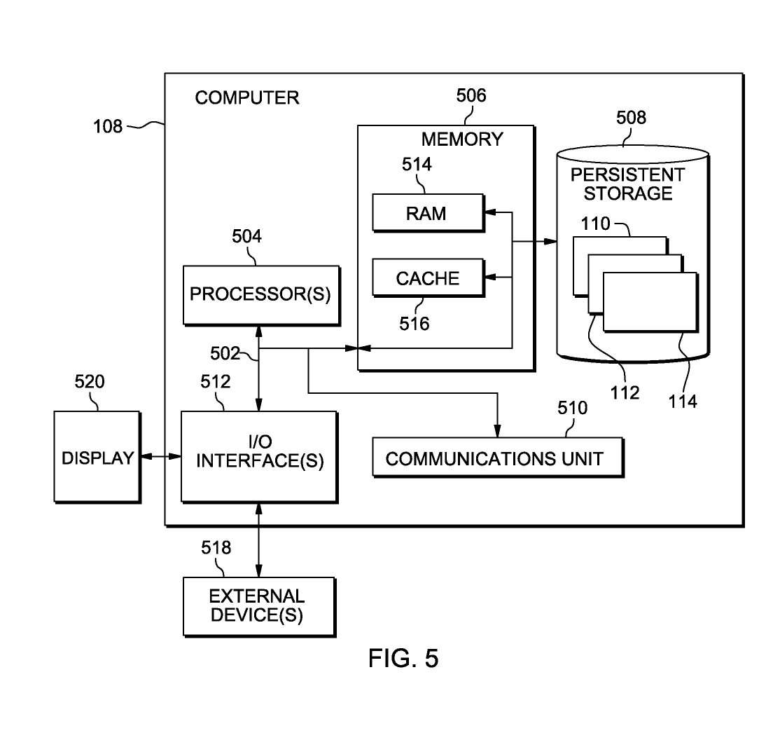

Client computing device 108 may be a desktop computer, a laptop computer, a tablet computer, a specialized computer server, a smart phone, or any programmable electronic device capable of communicating with server computer 104 via network 102 and with various components and devices within distributed data processing environment 100. In general, client computing device 108 represents any programmable electronic device or combination of programmable electronic devices capable of executing machine readable program instructions and communicating with other computing devices via a network, such as network 102. Client computing device 108 includes web browser 110, user interface 112, and magnification program 114. Client computing device 108 may include internal and external hardware components, as depicted and described in further detail with respect to FIG. 5.

Web browser 110 resides on client computing device 108. A web browser is a software application for retrieving, presenting and traversing information resources on the World Wide Web. Although web browsers are primarily intended to use the World Wide Web, they can also be used to access information provided by web servers in private networks or files in file systems. Web browser 110 can be used to retrieve web content 106 via network 102.

User interface 112 is a program that provides an interface between a user of magnification program 114 and any application which displays images or text. For example, user interface 112 enables a user to view magnified web content 106 through web browser 110 via network 102. A user interface, such as user interface 112, refers to the information (such as graphic, text, and sound) a program presents to a user and the control sequences the user employs to control the program. There are many types of user interfaces. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In an exemplary embodiment, user interface 112 is the interface between magnification program 114 and applications, such as web browser 110 which accesses web content 106 via network 102. In other embodiments, user interface 112 provides an interface between magnification program 114 and other applications, such as word processing and spreadsheet programs, that reside on client computing device 108.

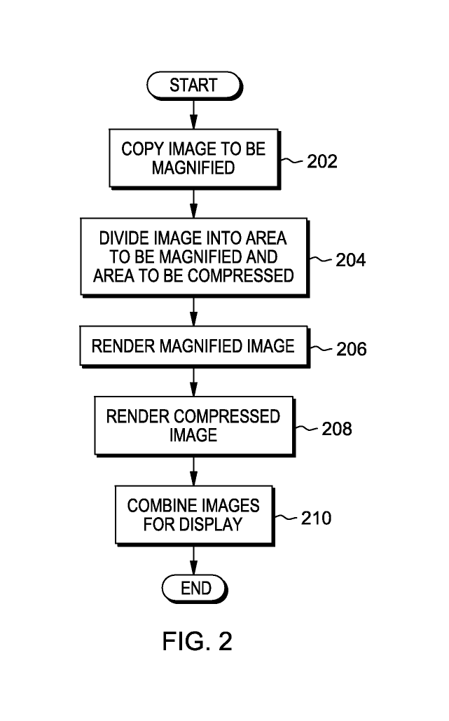

Magnification program 114 is a tool for magnifying content on a computer screen and displaying the magnified content with both focus and context. When low vision users are given subtle previews of the content that will arrive in their magnification portal, they can anticipate, and then navigation becomes easier. As the user moves the magnification viewer from left to right across the computer screen, what was once the previewed content, moves into full view, and what was once the central content, moves to the left into the post-view area. Magnification program 114 provides a user with “focus plus context”, which enables the user to see the area of primary interest presented in full, while at the same time receiving an overview impression of all the surrounding information that is coming into view. The focus is on the primary, magnified area, while the context is displayed in summary fashion around the magnified edges. Magnification program 114 compresses the content adjacent to the magnified area. The user notices the visually compressed adjacent areas and understands the magnified area is in the middle of the computer screen, while there is unread text surrounding the magnified area. Magnification program 114 is depicted and described in further detail with respect to FIGS. 2, 3, and 4.

FIG. 2 is a flowchart depicting operational steps of magnification program 114, on client computing device 108 within distributed data processing environment 100 of FIG. 1, for magnifying areas of an image displayed on a computing device with visible context, in accordance with an embodiment of the present invention.

Magnification program 114 copies the original image to be magnified (step 202). When a user initializes magnification program 114, a displayed image is copied for use in the subsequent steps. For example, if the image displayed on a computer screen is a web page, magnification program 114 copies the image of the web page as it is displayed at the moment magnification program 114 is opened.

Magnification program 114 divides the copied original image into two areas: the portion of the original image to be magnified and the portion of the original image to be visually compressed (step 204). The area to be magnified is a defined area around a pointer. In one embodiment, the pointer is a cursor positioned by the user manipulating a mouse. In another embodiment, where the display is a touch screen, the pointer may be positioned by the user's fingertip. The area to be visually compressed is the frame of the defined area around the pointer. In one embodiment, the size of the area to be magnified is pre-defined within magnification program 114. In another embodiment, the user may specify or select the size of the area to be magnified from a menu via user interface 112. In one embodiment, the area to be magnified is the shape of a rectangle that mimics the shape of the screen on which the image is displayed. In another embodiment, the area to be magnified is the shape of a circle that mimics the shape of a traditional magnifying glass. In yet another embodiment, the area to be magnified may take any shape that is convenient to the user. In all embodiments, the shape of the area to be visually compressed takes the shape of the area to be magnified by surrounding the area to be magnified. In one embodiment, the shape of the area to be magnified is pre-defined within magnification program 114. In another embodiment, the user may specify or select the shape of the area to be magnified from a menu via user interface 112.

Subsequent to dividing the original image into two areas, magnification program 114 renders the magnified image (step 206). Rendering is the process of generating an image from a model, by means of computer programs. As may be recognized by one skilled in the art, there exist a plurality of techniques for image rendering. Many rendering algorithms have been researched, and software used for rendering may employ a number of different techniques to obtain a final image. The magnified image is rendered according to a specified magnification ratio. In one embodiment, the magnification ratio is pre-defined. For example, the magnification ratio may be 200%; therefore, the magnified image is twice the size of the original image. In another embodiment, the user may be able to choose the magnification ratio for magnification program 114 from a menu via user interface 112. For example, the menu may provide four magnification ratios to choose from, such as 150%, 200%, 300%, and 400%. In yet another embodiment, the user may be able to customize the magnification ratio for magnification program 114 by inputting a ratio value via user interface 112. For example, the user may input a magnification ratio of 175%.

Magnification program 114 renders the visually compressed image (step 208). The frame of the defined area of the image that is magnified is rendered as a visually compressed image. If, for example, the original image is text, the compressed image is the same text that surrounds the magnified area, visually compressed to a significantly smaller size. If the original image is a photograph, the compressed image is a significantly smaller version of the area of the photograph that surrounds the magnified area. The visually compressed image is rendered according to a specified reduction ratio. In one embodiment, the reduction ratio is pre-defined. For example, the reduction ratio may be 2%, therefore the compressed image is two one hundredths the size of the original image. In another embodiment, the user may be able to choose the reduction ratio for magnification program 114 from a menu via user interface 112. For example, the menu may provide four reduction ratios to choose from, such as 0.5%, 1%, 5%, and 10%. In yet another embodiment, the user may be able to customize the reduction ratio for magnification program 114 by inputting a ratio value via user interface 112. For example, the user may input a reduction ratio of 15%. In yet another embodiment, the reduction ratio may be correlated to the magnification ratio, such that when the user chooses a magnification ratio, the reduction ratio is automatically adjusted.

Subsequent to rendering the magnified image and the visually compressed image, magnification program 114 combines the magnified image and the visually compressed image for display (step 210). Magnification program 114 superimposes one image with the other to create a final image such that the final image is the magnified area surrounded by the compressed area. Combining the two images allows the user to view the magnified area while anticipating the content that will come into view as the pointer is moved around the computer screen. With each movement of the pointer, magnification program 114 continually regenerates the images and displays an updated image that combines the magnified image and the compressed image.

Embodiments of magnification program 114 may be written in a plurality of programming languages as there are many tools and technologies that can yield the effect of magnified text surrounded by compressed text that trails off into divergent horizons. For example, magnification program 114 may be written in OpenGL®. An example of an OpenGL® version of magnification program 114 may begin by using the glCopyTexSubImage2D function to copy the original image and use that image as a texture that is applied to a regular grid. The texture coordinates of the grid are formed to give the appropriate compression, or distortion, of the trailing off. For example, the center of the magnified area is used as the center point for the coordinate. In the x-axis direction, Xnew=Xorg−a/b(Xorg−a), where Xorg is the original position of a pixel's value in the x-axis, and Xnew is the new, distorted position; “a” is the distance from the closest point to the center, while “b” is the most distant point. Distortion is done for all pixels using glTexCoord2f(x, y) and glVertex3f(x,y) to give the texture new coordinate values. Upon completion of distortion for all pixels, the distorted texture is re-projected to create the effect of the compressed, trailing-off image.

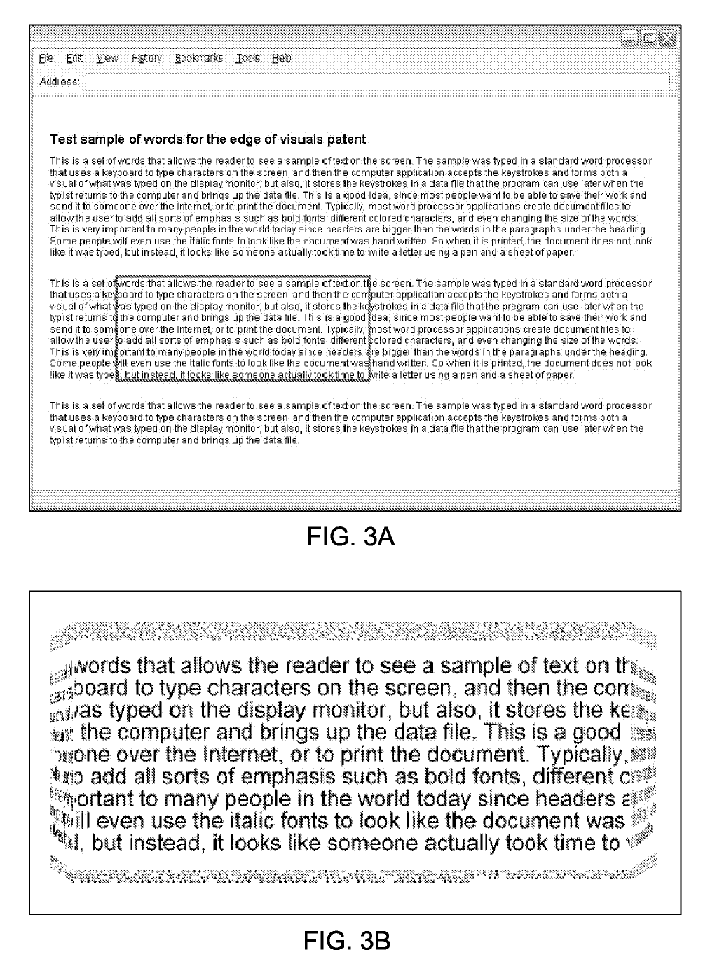

FIGS. 3A and 3B illustrate an example of magnified text in the center of a computer screen, in accordance with an embodiment of the present invention. FIG. 3A depicts an example of a page displayed on a web browser, such as web browser 110. The rectangle displayed toward the center of the page includes the portion of the image that is magnified upon initialization of magnification program 114. The area within the rectangle represents the “focus” area which is the area to be magnified, while the area of the rectangular frame is the “context” area which is the area to be compressed, as discussed previously with respect to step 204 of FIG. 2.

FIG. 3B depicts the combined image of the magnified image and the visually compressed image, as discussed previously with respect to step 210 of FIG. 2. The magnified text in the center is the focus. The focus is the image the user is reviewing. On the four sides surrounding the magnified area is the context. The context is summarized and condensed. The surrounding areas take up significantly less space than the context in the original image. The context is compressed and pushed to the edges of the magnified area. The compression is similar to the result of looking through a fish-eye lens, where the edge compresses the information, whether the information is text or an image. The predictable visual compression allows the low vision user to anticipate what is adjacent to the magnified area. By noticing the compressed adjacent areas, the user understands the current view is from a section in the middle of the computer screen. The compressed area to the right of the magnified area shows a summary of content that will come into view as the user moves from left to right across the computer screen. The image of the magnified and compressed text is displayed in the rectangle shown in FIG. 3A, while the remainder of the text displayed on the computer screen is unchanged.

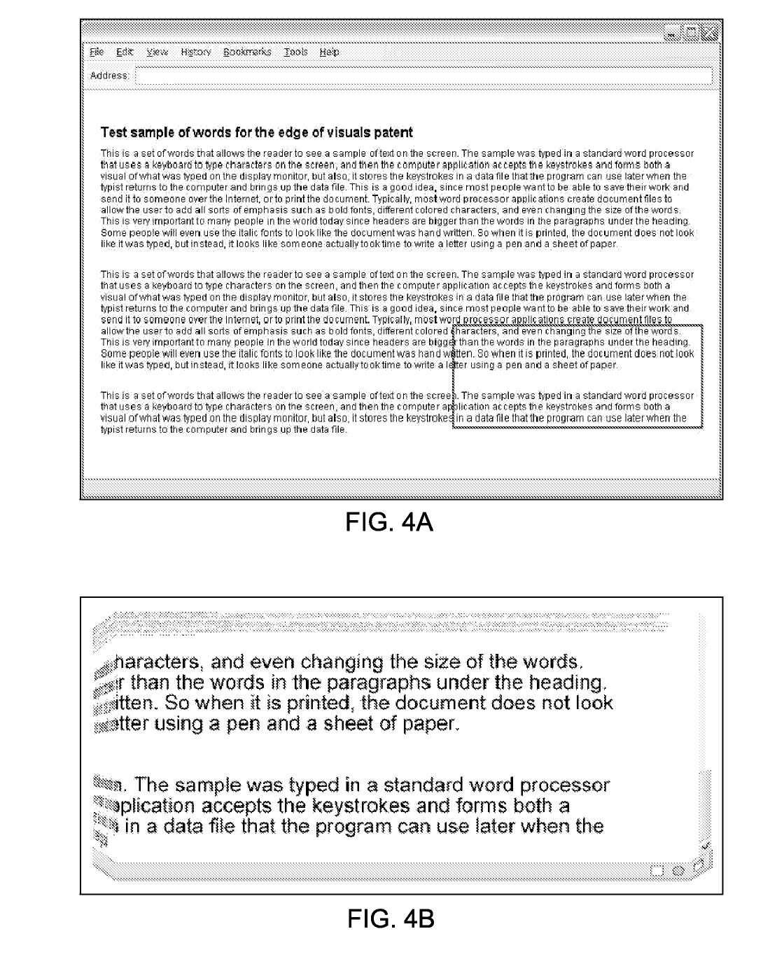

FIGS. 4A and 4B illustrate an example of magnified text in the lower right corner of a computer screen, in accordance with an embodiment of the present invention. Similar to FIG. 3A, FIG. 4A depicts an example of a page displayed on a web browser, such as web browser 110. The rectangle displayed toward the lower right corner of the page is the portion of the original image that is magnified upon initialization of magnification program 114. The area within the rectangle represents the “focus” area which is the area to be magnified, while the area of the rectangular frame is the “context” area which is the area to be compressed, as discussed previously with respect to step 204 of FIG. 2.

FIG. 4B depicts the combined image of the magnified image and the visually compressed image, as discussed previously with respect to step 210 of FIG. 2. The magnified text in the center is the focus. The focus is the image the user is reviewing. The compressed text above and to the left of the magnified area is the context. In this example, there is no compressed text to the right or below the magnified area. The lack of compressed text to the right and below the magnified area is a visual context cue from which the low vision user understands that the pointer in magnification program 114 has arrived at the bottom right corner of the computer screen.

FIG. 5 depicts a block diagram of components of client computing device 108 in accordance with an illustrative embodiment of the present invention. It should be appreciated that FIG. 5 provides only an illustration of one implementation and does not imply any limitations with regard to the environments in which different embodiments may be implemented. Many modifications to the depicted environment may be made.

Client computing device 108 includes communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications, and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) 514 and cache memory 516. In general, memory 506 can include any suitable volatile or non-volatile computer readable storage media.

Web browser 110, user interface 112, and magnification program 114 are stored in persistent storage 508 for execution by one or more of the respective computer processor(s) 504 via one or more memories of memory 506. In this embodiment, persistent storage 508 includes a magnetic hard disk drive. Alternatively, or in addition to a magnetic hard disk drive, persistent storage 508 can include a solid-state hard drive, a semiconductor storage device, a read-only memory (ROM), an erasable programmable read-only memory (EPROM), a flash memory, or any other computer readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices, including resources of server computer 104. In these examples, communications unit 510 includes one or more network interface cards. Communications unit 510 may provide communications through the use of either or both physical and wireless communications links. Web browser 110, user interface 112, and magnification program 114 may be downloaded to persistent storage 508 through communications unit 510.

I/O interface(s) 512 allows for input and output of data with other devices that may be connected to client computing device 108. For example, I/O interface(s) 512 may provide a connection to external device(s) 518 such as a keyboard, a keypad, a touch screen, and/or some other suitable input device. External device(s) 518 can also include portable computer readable storage media such as, for example, thumb drives, portable optical or magnetic disks, and memory cards. Software and data used to practice embodiments of the present invention, e.g., web browser 110, user interface 112, and magnification program 114, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method for magnifying areas of an image displayed on a computing device, the method comprising:
copying, by one or more computer processors, an image displayed on a computing device;
dividing, by the one or more computer processors, the copied image into at least two areas, wherein a first area is a portion of the image to be magnified and a second area is a portion of the image to be visually compressed;
rendering, by the one or more computer processors, the first area as a magnified image;
rendering, by the one or more computer processors, the second area as a visually compressed image;
combining, by the one or more computer processors, the magnified image and the visually compressed image into a new image; and
displaying, by the one or more computer processors, the new image.

2. The method of claim 1, wherein combining, by the one or more computer processors, the magnified image and the visually compressed image into a new image comprises superimposing the magnified image with the visually compressed image such that the visually compressed image surrounds the magnified image.

3. The method of claim 1, wherein a magnification ratio of the magnified image to the copied image includes one of: a pre-defined ratio and a user-specified ratio.

4. The method of claim 1, wherein a reduction ratio of the visually compressed image to the copied image includes one of: a pre-defined ratio, a user-specified ratio, and a ratio correlated to a magnification ratio of the magnified image.

5. The method of claim 1, wherein a size of the magnified image includes one of: a pre-defined size and a user-specified size.

6. The method of claim 1, wherein a shape of the new image includes one of: a rectangle, a circle, and a user-specified shape.

7. The method of claim 1, wherein dividing the copied image into at least two areas further comprises receiving, by the one or more computer processors, a selected shape of the image to be magnified.

8. The method of claim 1, wherein dividing the copied image into at least two areas further comprises receiving, by the one or more computer processors, a selected size of the image to be magnified.

9. A computer program product for magnifying areas of an image displayed on a computing device, the computer program product comprising:
one or more computer readable storage media and program instructions stored on the one or more computer readable storage media, the program instructions comprising:
program instructions to copy an image displayed on a computing device;
program instructions to divide the copied image into at least two areas, wherein a first area is a portion of the image to be magnified and a second area is a portion of the image to be visually compressed;
program instructions to render the first area as a magnified image;
program instructions to render the second area as a visually compressed image;
program instructions to combine the magnified image and the visually compressed image into a new image; and
program instructions to display the new image.

10. The computer program product of claim 9, wherein program instructions to combine the magnified image and the visually compressed image into a new image comprises superimposing the magnified image with the visually compressed image such that the visually compressed image surrounds the magnified image.

11. The computer program product of claim 9, wherein a magnification ratio of the magnified image to the copied image includes one of: a pre-defined ratio and a user-specified ratio.

12. The computer program product of claim 9, wherein a reduction ratio of the visually compressed image to the copied image includes one of: a pre-defined ratio, a user-specified ratio, and a ratio correlated to a magnification ratio of the magnified image.

13. The computer program product of claim 9, wherein dividing the copied image into at least two areas further comprises program instructions to receive a selected shape of the image to be magnified.

14. The computer program product of claim 9, wherein dividing the copied image into at least two areas further comprises program instructions to receive a selected size of the image to be magnified.

15. A computer system for magnifying areas of an image displayed on a computing device, the computer system comprising:
one or more computer processors;
one or more computer readable storage media;
program instructions stored on the computer readable storage media for execution by at least one of the one or more processors, the program instructions comprising:
program instructions to copy an image displayed on a computing device;
program instructions to divide the copied image into at least two areas, wherein a first area is a portion of the image to be magnified and a second area is a portion of the image to be visually compressed;
program instructions to render the first area as a magnified image;
program instructions to render the second area as a visually compressed image;
program instructions to combine the magnified image and the visually compressed image into a new image; and
program instructions to display the new image.

16. The computer system of claim 15, wherein program instructions to combine the magnified image and the visually compressed image into a new image comprises superimposing the magnified image with the visually compressed image such that the visually compressed image surrounds the magnified image.

17. The computer system of claim 15, wherein a magnification ratio of the magnified image to the copied image includes one of: a pre-defined ratio and a user-specified ratio.

18. The computer system of claim 15, wherein a reduction ratio of the visually compressed image to the copied image includes one of: a pre-defined ratio, a user-specified ratio, and a ratio correlated to a magnification ratio of the magnified image.

19. The computer system of claim 15, wherein dividing the copied image into at least two areas further comprises program instructions to receive a selected shape of the image to be magnified.

20. The computer system of claim 15, wherein dividing the copied image into at least two areas further comprises program instructions to receive a selected size of the image to be magnified.
